(19) United States
(12) Patent Application Publication
(10) Pub. No.: US 2018/0210113 A1
(43) Pub. Date: Jul. 26, 2018

(54) OPTICAL LENS

(71) Applicant: Genius Electronic Optical Co., Ltd., Taichung City (TW)

(72) Inventors: Chien-Cheng Huang, Taichung City (TW); Ching-Hung Chen, Taichung City (TW)

(73) Assignee: Genius Electronic Optical Co., Ltd., Taichung City (TW)

(21) Appl. No.: 15/458,992

(22) Filed: Mar. 15, 2017

(30) Foreign Application Priority Data
Jan. 24, 2017 (CN) 201710059288.3

(51) Int. Cl. G02B 1/04; G02B 13/18

(52) U.S. Cl. CPC G02B 1/041; G02B 13/18

(57) ABSTRACT

An optical lens including an assembling portion and an optical portion is provided. The assembling portion is configured to fix the optical lens. The optical portion is configured to allow imaging rays to pass through. The assembling portion is located on the edge of the optical portion. The optical portion includes a first surface, a second surface, and a side wall, and the first surface surrounds the second surface. The side wall connects the first surface and the second surface and is located between the first surface and the second surface. The side wall surrounds the second surface, and a step difference exists on the boundary between the first surface and the second surface along the direction of an optical axis of the optical lens.

### CROSS-REFERENCE TO RELATED APPLICATION

This application claims the priority benefit of Chinese application serial no. 201710059288.3, filed on Jan. 24, 2017. The entirety of the above-mentioned patent application is hereby incorporated by reference herein and made a part of this specification.

### BACKGROUND OF THE INVENTION

### Field of the Invention

The invention relates to an optical component and particularly relates to an optical lens.

### Description of Related Art

As the varieties of portable electronic devices have increased, the varieties of optical lenses, crucial components of the portable electronic devices, also increase. The applications of the optical lenses are not only limited to photographing and filming but also extended to environment monitoring and dashboard camera recording. As the image sensor techniques progresses, customers become more and more demanding for imaging quality.

Products having the optical imaging lenses with a high thickness ratio, i.e. the ratio of the maximum thickness to the minimum thickness, often encounter problems of reduced yield during fabrication, which results from the difficulty in discharging air wrapped by plastic materials in a lens mold chamber while filling the lens mold chamber with the high thickness ratio. Thereby, the surfaces of lenses cannot fully transfer the form of the mold, and thus irregular defects are likely to be formed on the surface, which may further lead to the decrease in imaging quality due to stray light generated during imaging. As a result, designing an optical lens to solve the problems of stray light has always been the pursuit of people from industries, official, and academic fields.

### SUMMARY OF THE INVENTION

The invention provides an optical lens configured to solve the problems of stray light.

An embodiment of the invention provides an optical lens including an assembling portion and an optical portion. The assembling portion is configured to fix the optical lens. The optical portion is configured to allow imaging rays to pass through. The assembling portion is located on an edge of the optical portion. The optical portion includes a first surface, a second surface, and a side wall, wherein the first surface surrounds the second surface. The side wall connects the first surface and the second surface and is located between the first surface and the second surface. The side wall surrounds the second surface, and a step difference exists on a boundary between the first surface and the second surface along a direction of an optical axis of the optical lens.

In an embodiment of the invention, the second surface is lifted above the first surface.

In an embodiment of the invention, the second surface sinks into the first surface.

In an embodiment of the invention, a height of the side wall in a direction parallel to the optical axis is smaller than 10 μm.

In an embodiment of the invention, the side wall extends in a direction parallel to the optical axis.

Another embodiment of the invention provides an optical lens including an assembling portion and an optical portion. The assembling portion is configured to fix the optical lens. The optical portion is configured to allow imaging rays to pass through. The assembling portion is located on an edge of the optical portion. The optical portion includes a first surface, a second surface, and a boundary bulge, wherein the first surface surrounds the second surface. The boundary bulge connects the first surface and the second surface and is located between the first surface and the second surface.

In an embodiment of the invention, the first surface and the second surface are spherical or aspherical.

In an embodiment of the invention, the first surface has circular symmetry with respect to an optical axis of the optical lens.

In an embodiment of the invention, the second surface has circular symmetry with respect to an optical axis of the optical lens.

In an embodiment of the invention, a ratio of a maximum thickness to a minimum thickness of the optical portion in a direction parallel to the optical axis is greater than 1.7.

In an embodiment of the invention, the second surface is configured within a clear aperture of the optical lens.

In an embodiment of the invention, a height of the boundary bulge in a direction parallel to the optical axis is smaller than 10 μm.

Based on the above, the advantageous effects of the optical lens in the embodiments of the invention include the following. The structural design of the boundary between the first surface and the second surface of the optical lens avoids air from remaining in the mold chamber where the optical lens is formed during the manufacture of the optical lens. Thereby, the overall optical surface of the optical lens remains intact, the problem of stray light may be solved, and imaging quality may be improved.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic cross-sectional view of an optical lens in a first embodiment of the invention.

FIG. 1B is a schematic frontal view of the optical lens in FIG. 1A.

FIG. 1C is a schematic enlarged view of a region B of the optical lens in FIG. 1A.

FIG. 2 is a schematic enlarged view of a portion of an optical lens in a second embodiment of the invention.

FIG. 3 is a schematic enlarged view of a portion of an optical lens in a third embodiment of the invention.

FIG. 4 is a schematic cross-sectional view of an optical lens in a fourth embodiment of the invention.

FIG. 5 is a schematic cross-sectional view of an optical lens in a fifth embodiment of the invention.

FIG. 6 is a schematic cross-sectional view of an optical lens in a sixth embodiment of the invention.

FIG. 7 is a schematic cross-sectional view of the optical lens in FIG. 1A and a manufacturing mold of the optical lens.

### DESCRIPTION OF THE EMBODIMENTS

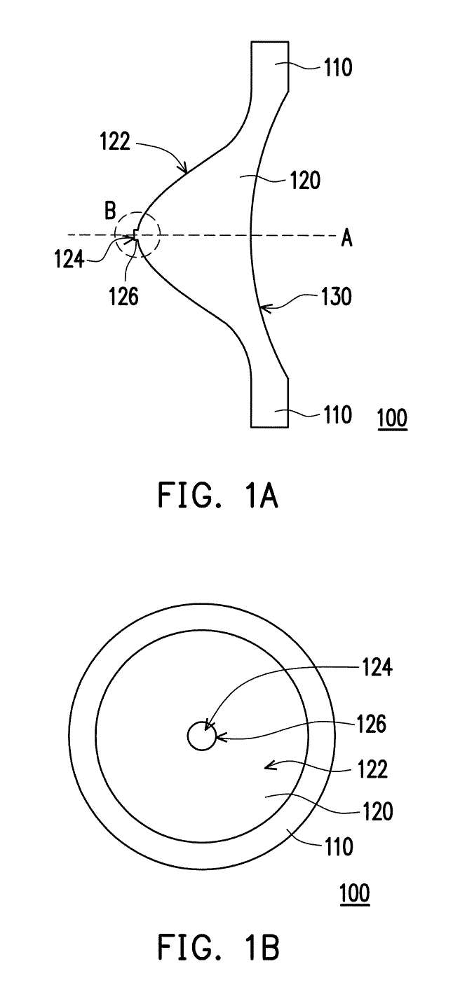

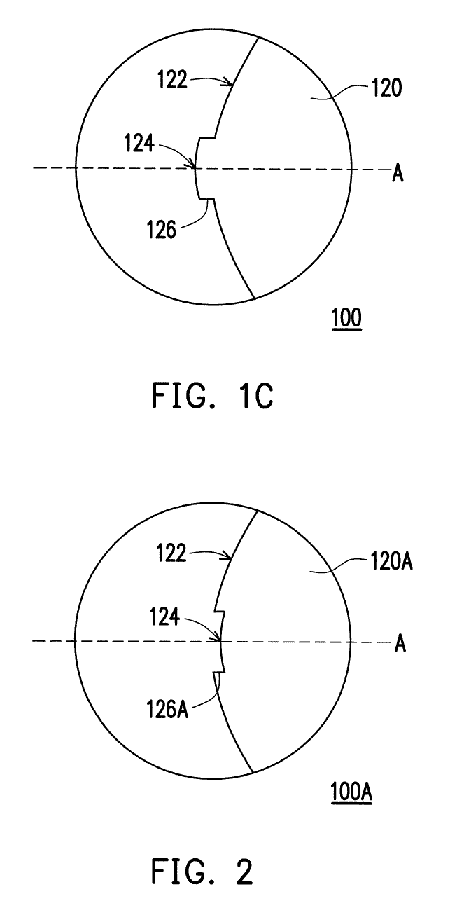

FIG. 1A is a schematic cross-sectional view of an optical lens in a first embodiment of the invention. FIG. 1B is a schematic frontal view of the optical lens in FIG. 1A. FIG. 1C is a schematic enlarged view of a region B of the optical lens in FIG. 1A. Please refer to FIG. 1A to FIG. 1C. In this embodiment of the invention, an optical lens 100 may be applied in an optical imaging lens in portable electronic devices, such as mobile phones, cameras, tablet computers, personal digital assistants (PDAs), etc. Alternatively, the optical lens 100 may also be applied in virtual reality VR) display devices and other stereopsis display devices as well as in secondary optical components, such as an illuminating optical lens, a car lens, etc. According to the embodiment, the optical lens 100 includes an assembling portion 110 and an optical portion 120. The assembling portion 110 is configured to fix the optical lens 100 and is located on the edge of the optical portion 120. The optical portion 120 is configured to allow imaging rays to pass through. The optical portion 120 includes a first surface 122, a second surface 124, and a side wall 126, wherein the first surface 122 surrounds the second surface 124.

In this embodiment of the invention, the first surface 122 and the second surface 124 are spherical or aspherical. Thus, the optical lens 100 in this embodiment of the invention may be made to be a spherical or an aspherical lens in accordance with demand. The invention is not limited to either of them. Furthermore, in the embodiment of the invention, both of the first surface 122 and the second surface 124 have circular symmetry with respect to an optical axis A. In other words, every cross-section of the optical portion 120 obtained through performing a cutting action along any plane that includes the optical axis A is identical. As a result, the brightness of imaging frames of the optical lens 100 is even. Nevertheless, the invention is not limited to the above.

In this embodiment of the invention, the second surface 124 is configured within a clear aperture of the optical lens 100. In other words, the area occupied by the second surface 124 falls completely within the clear aperture of the optical lens 100. The side wall 126 located between the first surface 122 and the second surface 124 also falls within the clear aperture of the optical lens 100. Thus, air may be prevented from remaining in the mold chamber where the optical lens 100 is formed during the manufacture of the optical lens 100. Furthermore, irregular defects may not be formed on a lens surface within the clear aperture, so as to solve the problems of stray light and improve imaging quality. In addition, in the embodiment of the invention, the first surface 122 is also configured within the clear aperture of the optical lens 100, such that the overall optical surface of the optical lens 100 remains intact, the problems of stray light may be solved, and imaging quality may be improved. Nevertheless, the invention is not limited to the above.

In the embodiment of the invention, a ratio of the maximum thickness to the minimum thickness of the optical portion 120 in a direction parallel to the optical axis A is greater than 1.7. For instance, the maximum ratio of the maximum thickness to the minimum thickness of the optical portion 120 in the direction parallel to the optical axis A is 7. In other words, during the manufacture of the optical lens 100 with the thickness ratio greater than 1.7, air may be prevented from remaining in the mold chamber where the optical lens 100 is formed because of the designs of the first surface 122, the second surface 124, and the side wall 126 of the optical lens 100 in the embodiment of the invention. As such, the overall optical surface of the optical lens 100 remains intact, the problems of stray light may be solved, and imaging quality may be improved.

In the embodiment of the invention, the side wall 126 connects the first surface 122 and the second surface 124 and is located between the first surface 122 and the second surface 124. Moreover, the side wall 126 surrounds the second surface 124, and a step difference exists on a boundary between the first surface 122 and the second surface 124 in a direction parallel to the optical axis A of the optical lens 100. In other words, in the embodiment of the invention, the first surface 122 is not directly connected to the second surface 124; instead, the first surface 122 and the second surface 124 are distinguished by and connected by the step difference.

In more detail, the second surface 124 located at the center of the optical portion 120 is lifted above the first surface 122. The side wall 126 is thus formed between the first surface 122 and the second surface 124, as shown in FIG. 1C. As a result, air can be effectively prevented from remaining in the mold chamber where the optical lens 100 is formed during the manufacture of the optical lens 100, given that the production cost is reduced due to the simplification of the manufacturing process. Additionally, in the embodiment of the invention, an extension direction of the side wall 126 is parallel to the optical axis A, and a height of the side wall 126 in the direction parallel to the optical axis A is smaller than 10 μm. Thereby, no stray light is generated. Nevertheless, the invention is not limited to the above.

FIG. 2 is a schematic enlarged view of a portion of an optical lens in a second embodiment of the invention. Please refer to FIG. 2. An optical lens 100A provided in the embodiment is similar to the optical lens 100 in FIG. 1A. One of the major differences between the optical lens 100A and the optical lens 100 lies in that a second surface 124 of an optical portion 120A of the optical lens 100A sinks into a first surface 122, for instance. In other words, the first surface 122 located outside the optical portion 120A is lifted above the second surface 124. A side wall 126A sinking into a center location is thus formed between the second surface 124 and the first surface 122. As a result, air can be effectively prevented from remaining in the mold chamber where the optical lens 100A is formed during the manufacture of the optical lens 100A, given that the production cost is reduced due to the simplification of the manufacturing process. Furthermore, in the embodiment of the invention, the extension direction of the side wall 126A is parallel to the optical axis A, and a height of the side wall 126A in the direction parallel to the optical axis A is smaller than 10 μm. Thereby, no stray light is generated. Nevertheless, the invention is not limited to the above.

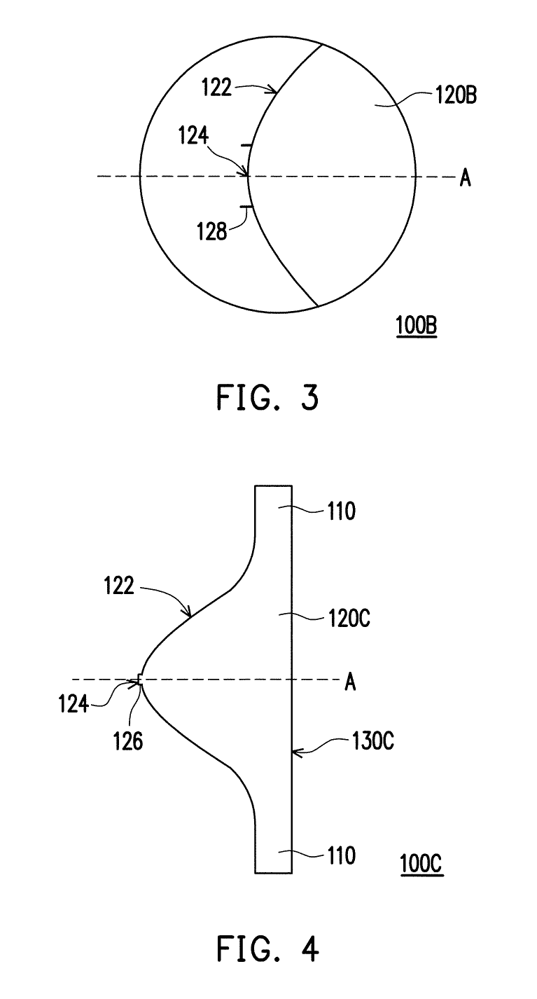

FIG. 3 is a schematic enlarged view of a portion of an optical lens in a third embodiment of the invention. Please refer to FIG. 3. An optical lens 100B provided in the embodiment is similar to the optical 100 in FIG. 1A. One of the major differences between the optical lens 100B and the optical lens 100 lies in that an optical portion 120B provided in the embodiment of the invention further includes a boundary bulge 128, for instance. The boundary bulge 128 is located between a first surface 122 and a second surface 124 and connects the first surface 122 and the second surface 124. In other words, the boundary bulge 128 is lifted above the first surface 122 and the second surface 124, resulting in the formation of a bulge structure surrounding the second surface 124, as shown in FIG. 3. As a result, due to the design of the boundary bulge 128, air can be effectively prevented from remaining in the mold chamber where the optical lens 100B is formed during the manufacture of the optical lens 100B. Thereby, the overall optical surface of the optical lens 100B remains intact, the problems of stray light may be solved, and imaging quality may be improved.

In the embodiment of the invention, a height of the boundary bulge 128 in the direction parallel to the optical axis A of the optical lens 100B is smaller than 10 μm. Thereby, no stray light is generated. As provided in the embodiment of the invention, the boundary bulge 128 surrounds the second surface 124, and thus a curricular bulge structure is formed. In other embodiments of the invention, however, different bulge structures may be formed in response to different manufacturing methods of the optical lens. For instance, the bulge structure may be constituted by non-consecutive bulge structures arranged in a ring-like manner, and heights of the bulge structures are respectively smaller than 10 μm in a direction parallel to the optical axis A of the optical lens. As such, no stray light is generated, whereas the invention is not limited thereto.

FIG. 4 is a schematic cross-sectional view of an optical lens in a fourth embodiment of the invention. Please refer to FIG. 4. An optical lens 100C provided in the embodiment is similar to the optical 100 in FIG. 1A. One of the major differences between the optical lens 100C and the optical lens 100 lies in that a third surface 130C of an optical portion 120C is different from the third surface 130 in FIG. 1A, for instance. In more detail, the third surface 130C is a plane, but the third surface 130 in FIG. 1A is a concave surface. As a result, the optical lens 100C provided in the embodiment of the invention serves as a plane-convex lens while the optical lens 100 of FIG. 1A serves as a concave-convex lens.

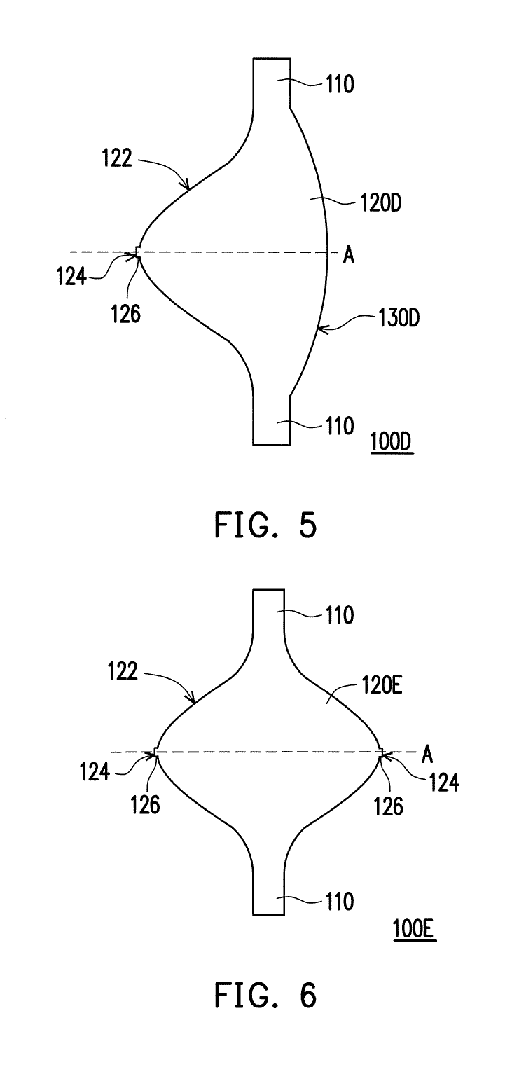

FIG. 5 is a schematic cross-sectional view of an optical lens in a fifth embodiment of the invention. Please refer to FIG. 5. An optical lens 100D provided in the embodiment is similar to the optical 100 in FIG. 1A. One of the major differences between the optical lens 100D and the optical lens 100 lies in that a third surface 130D of an optical portion 120D is different from the third surface 130 in FIG. 1A, for instance. In more detail, the third surface 130D is a convex surface. As a result, the optical lens 100D provided in the embodiment of the invention may be applied as a biconvex lens.

However, the invention does not limit the surface shapes of the optical lens. That is to say, the optical lens is not limited to the concave-convex lens, the plane-convex lens, or the biconvex lens mentioned above. In other embodiments, the optical lens may be an aspherical lens or a lens with other surface shapes.

FIG. 6 is a schematic cross-sectional view of an optical lens in a sixth embodiment of the invention. Please refer to FIG. 6. An optical lens 100E provided in the embodiment is similar to the optical lens 100 in FIG. 1A. One of the major differences between the optical lens 100E and the optical lens 100 lies in that the first surface 122, the second surface 124, and the side wall 126 exist on both sides of an optical portion 120E of the optical lens 100E, for instance. Thereby, when imaging rays pass through the optical portion 120E, the stray light is not generated on any of the two surfaces of the optical portion 120E, and imaging clarity and imaging brightness may be improved twice.

On the other hand, in this embodiment, the second surface 124 on both sides of the optical portion 120E is lifted above the first surface 122. In other embodiments, however, the second surface 124 on one of the two sides of the optical portion 120E may sink into the first surface 122, or a boundary bulge 128 may be configured between the first surface 122 and the second surface 124, as shown in FIG. 3. In other words, the optical surface structures on both sides of the optical portion 120E may be any of the structures mentioned above in accordance with demands. Thereby, no stray light is generated on both surfaces, and the imaging clarity and the imaging brightness may be improved twice. Nevertheless, the invention is not limited to the above.

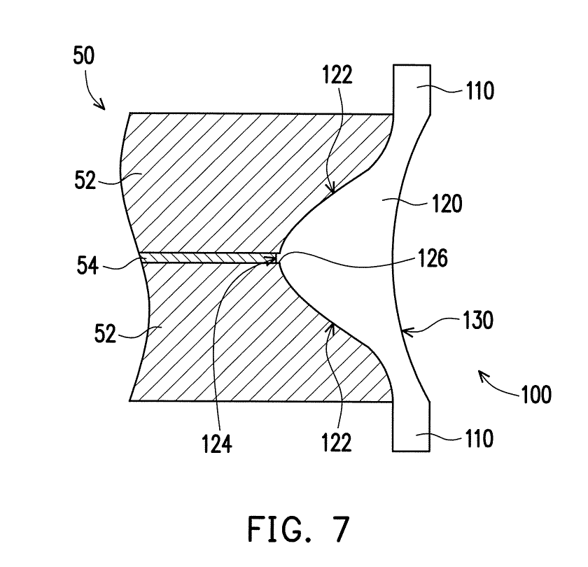

FIG. 7 is a schematic cross-sectional view of the optical lens in FIG. 1A and a manufacturing mold of the optical lens in FIG. 1A. Please refer to FIG. 1A, FIG. 1C, and FIG. 7 altogether. In the embodiment of the invention, the first surface 122, the second surface 124, and the side wall 126 of the optical lens 100 may be formed by a mold capable of being disassembled. To be more specific, a mold 50 configured to manufacture the optical lens 100 may include a first mold core 52 and a second mold core 54. The first mold core 52 is configured to form the first surface 122 of the optical lens 100, and the second mold core 54 is configured to form the second surface 124 of the optical lens 100. Further, the optical lens 100, of which the second surface 124 is lifted above the first surface 122, may be formed by enabling the second mold core 54 to sink into the first mold core 52, as shown in FIG. 1C. As a result, excessive and unnecessary air in the mold chamber may be discharged through the gap between the first mold core 52 and the second mold core 54 to prevent irregular defects from being formed on the surface of the optical lens 100 due to the air remaining between the optical lens 100 and the first mold core 52 and between the optical lens 100 and the second mold core 54. That is to say, owing to said design, the overall optical surface of the optical lens 100 remains intact, the problems of stray light are solved, and imaging quality may be improved.

In other embodiments, the arrangement of the first mold core 52 and the second mold core 54 may be slightly adjusted to enable the second mold core 54 to be lifted above the first mold core 52. The optical lens 100A, of which the second surface 124 sinks into the first surface 122 as shown in FIG. 2, is thereby formed. Alternatively, in other embodiments, the first mold core 52 and the second mold core 54 may be further adjusted to enable the surface of the second mold core to be aligned with the surface of the first mold core. Thereby, the optical lens 100B with the boundary bulge 128 located between the first surface 122 and the second surface 124 may be formed by the gap between the first mold core 52 and the second mold core 54, as shown in FIG. 3.

Additionally, in other embodiments, there are other ways, e.g., by way of drilling, to discharge excessive and unnecessary air in the optical lens 100 during the manufacture of the optical lens 100, and the invention is not limited to the above.

To sum up, the advantageous effects of the optical lens in the embodiments of the invention include the following: the structural design of the boundary between the first surface and the second surface of the optical lens avoids air from remaining in the mold chamber where the optical lens is formed during the manufacture of the optical lens, Thereby, the overall optical surface of the optical lens remains intact, the problems of stray light may be solved, and imaging quality may be improved.

It will be apparent to those skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. An optical lens, comprising:
an assembling portion configured to fix the optical lens; and
an optical portion configured to allow imaging rays to pass through, wherein the assembling portion is located on an edge of the optical portion, the optical portion comprising:
a first surface;
a second surface, wherein the first surface surrounds the second surface; and
a side wall connecting the first surface and the second surface and located between the first surface and the second surface, wherein the side wall surrounds the second surface, and a step difference exists on a boundary between the first surface and the second surface along a direction of an optical axis of the optical lens.

2. The optical lens according to claim 1, wherein the first surface and the second surface are spherical or aspherical.

3. The optical lens according to claim 1, wherein the first surface has circular symmetry with respect to the optical axis.

4. The optical lens according to claim 1, wherein the second surface has curricular symmetry with respect to the optical axis.

5. The optical lens according to claim 1, wherein a ratio of a maximum thickness to a minimum thickness of the optical portion in a direction parallel to the optical axis is greater than 1.7.

6. The optical lens according to claim 1, wherein the second surface is configured within a clear aperture of the optical lens.

7. The optical lens according to claim 1, wherein the second surface is lifted above the first surface.

8. The optical lens according to claim 1, wherein the second surface sinks into the first surface.

9. The optical lens according to claim 1, wherein a height of the side wall in a direction parallel to the optical axis is smaller than 10 μm.

10. The optical lens according to claim 1, wherein the side wall extends in a direction parallel to the optical axis.

11. An optical lens, comprising:
an assembling portion configured to fix the optical lens;
an optical portion configured to allow imaging rays to pass through, wherein the assembling portion is located on an edge of the optical portion, the optical portion comprising:
a first surface;
a second surface, wherein the first surface surrounds the second surface; and
a boundary bulge connecting the first surface and the second surface and located between the first surface and the second surface.

12. The optical lens according to claim 11, wherein the first surface and the second surface are spherical or aspherical.

13. The optical lens according to claim 11, wherein the first surface has circular symmetry with respect to an optical axis of the optical lens.

14. The optical lens according to claim 11, wherein the second surface has curricular symmetry with respect to an optical axis of the optical lens.

15. The optical lens according to claim 11, wherein a ratio of a maximum thickness to a minimum thickness of the optical portion in a direction parallel to an optical axis of the optical lens is greater than 1.7.

16. The optical lens according to claim 11, wherein the second surface is configured within a clear aperture of the optical lens.

17. The optical lens according to claim 11, wherein a height of the boundary bulge in a direction parallel to an optical axis of the optical lens is smaller than 10 μm.
